(19) United States
(12) Patent Application Publication
(10) Pub. No.: US 2009/0036194 A1
(43) Pub. Date: Feb. 5, 2009

(54) System for Playing a Bingo-Type Game

(75) Inventors: Theo Naicker, La Lucia (ZA); Tony Yunnie, La Lucia (ZA); Jon Hutchings, La Lucia (ZA); Devan Govender, Umdloti (ZA)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Waterleaf Limited, Douglas (GB)

(21) Appl. No.: 10/579,806

(22) PCT Filed: Dec. 10, 2004
(86) PCT No.: PCT/IB04/04060

§ 371 Date: Aug. 7, 2007

(30) Foreign Application Priority Data
Dec. 10, 2003 (GB) 0328604.4

(51) Int. Cl. A63F 9/24; A63F 13/12

(52) U.S. Cl. 463/19; 463/22; 463/20; 463/25; 463/42

(57) ABSTRACT

A system for playing a bingo-type game comprises a number of player stations, a random event generator capable of generating a number of random events upon which an outcome of a game of bingo is based, a secondary display means corresponding to each player station, the secondary display means being instructable by the player station to display a simulation of the turn of the game of bingo, and a primary display means corresponding to each player station, the primary display means being instructable by the player station to display to a player a simulation of a turn of a different entertainment game. Each player station is operable by a player to place a wager on a turn of the game of bingo. The outcome of the turn of the game of bingo is either an unfavourable outcome in which the player forfeits the wager, and at least one favourable outcome in which the player wins a corresponding prize. The turn of the different entertainment game has an outcome that is unfavourable outcome when the outcome of the turn of the game of bingo is an unfavourable outcome, and an outcome that causes the player to win the same corresponding prize as the game of bingo when the outcome of the turn of the game of bingo is a favourable outcome.

### FIELD OF THE INVENTION

This invention relates to a system for playing a bingo-type game and, more particularly, to a system for playing a bingo-type game that includes an associated entertainment feature. The invention extends to a method of operation of a system for playing a bingo-type game.

### BACKGROUND TO THE INVENTION

There exists a class of electronic gaming systems that can be used to play bingo-type games. A bingo-type game is played with predetermined “cards” in the form of data structures that include a number of symbols randomly arranged in a grid of positions. In the course of play, symbols are selected randomly from an available pool of symbols and matched to the symbols on the cards. A card having matching symbols arranged in a predetermined pattern is a winning card and qualifies a player with whom that card is associated to win a prize.

The Indian Gaming Regulatory Act (IGRA) of the United States defines a certain class of game, namely a Class 11 game, as including the game of bingo, irrespective of whether or not electronic, computer, or other technological aids are used in conjunction with the game.

A disadvantage of bingo games is that the probability of winning a prize, or losing, with a particular card is always determined by a fixed set of constraints, which include a number of symbols available in the pool of symbols, the predetermined patterns to be matched, and the number of grid positions on the card. For a given set of constraints, the probability of winning is fixed, and varying the constraints has only a limited effect on the probability of winning a prize.

It is desirable to modify a Class II bingo game to provide an enhanced entertainment feature that will allow a player to win any one of a number of different desirable prizes available during play.

### OBJECT OF THE INVENTION

It is an object of this invention to provide a system for playing a bingo-type game, and a method of operation thereof, that will, at least partially, alleviate the abovementioned difficulties and disadvantages.

### SUMMARY OF THE INVENTION

In accordance with this invention there is provided a system for playing a bingo-type game, comprising:

a plurality of player stations, each player station being operable by a player to place a wager on a turn of a game of bingo;

a random event generator activatable to generate a number of random events upon which an outcome of the game of bingo is based, the outcome being either an unfavourable outcome in which the player forfeits the wager, and at least one favourable outcome in which the player wins a corresponding prize;

a secondary display means instructable by the player station to display a simulation of the turn of the game of bingo; and

a primary display means instructable by the player station to display to the player a simulation of a turn of a different entertainment game, the turn of the different entertainment game having an outcome that is an unfavourable outcome when the outcome of the turn of the game of bingo is an unfavourable outcome, and causing the player to win the same corresponding prize as the game of bingo when the outcome of the turn of the game of bingo is a favourable outcome.

Further features of the invention provide for the random event generator to be executable in a gaming server remote from the plurality of player stations, for the gaming server to be communicable with each one of the plurality of remote player stations by means of a communication network, for the different entertainment game to be a game of video slots, for the game of bingo to have 75 uniquely numbered balls, for a random event generated by the random event generator to correspond to the drawing at random of one of the 75 uniquely numbered balls, for a player bingo card associated with the game of bingo to have 25 positions thereon arranged in a 5 by 5 grid, each grid position being numbered with a respective random number from one to 75, for one favourable outcome of the game of bingo to correspond to a game-ending pattern causing the turn of the game of bingo to terminate, for the game-ending pattern to arise when all the numbers on at least one player bingo card match the numbers drawn by the random event generator, for the game of bingo to have a plurality of further favourable outcomes, and for each one of the plurality of further favourable outcomes to arise when all the numbers in a predetermined pattern on at least one player bingo card match the numbers drawn by the random event generator.

Still further features of the invention provide for the random event generator to draw at random a first set of 24 of the 75 balls, for the gaming server to transmit data corresponding to the first set of 24 balls to each one of the player stations, for each one of the player stations to activate a prize claiming means operable by a player to claim any favourable outcome arising from the first set of 24 balls, for the prize claiming means to be a pushbutton on the player station, alternatively an activatable icon on the primary display means, and for the prize claiming means to be operable by a player for a predetermined period of time.

Still further features of the invention provide for the random event generator to draw at random further balls one at a time, for the gaming server to check for the occurrence of a game-ending pattern on any of the player bingo cards after the drawing of each ball, for the gaming server to transmit data corresponding to all the drawn balls necessary for the occurrence of the game-ending pattern to each one of the player stations if the game-ending pattern is not the last possible game-ending pattern in the turn of the game of bingo, for each one of the player stations to activate the prize claiming means operable by a player to claim a favourable outcome arising from the occurrence of the game-ending pattern, and for the prize claiming means to be operable by a player for a predetermined period of time, and for the gaming server to terminate the turn of the game of bingo if a player claims the favourable outcome within the predetermined period of time.

Yet further features of the invention provide for the random event generator to draw at random all the remaining balls if the game-ending pattern is the last possible game-ending pattern in the turn of the game of bingo, for the gaming server to transmit data corresponding to all the drawn balls necessary for the occurrence of the last game-ending pattern and the remaining balls to each one of the player stations, for each one of the player stations to activate the prize claiming means operable by a player to claim a favourable outcome arising from the occurrence of the last possible game-ending pattern, for the gaming server to terminate the turn of the game of bingo if a player claims the favourable outcome, and for the prize claiming means to remain activated until a player claims the favourable outcome.

The invention extends to a method of operation of a system for playing a bingo-type game, comprising the steps of:

enabling each one of a plurality of player stations for operation by a respective player to place a wager on a turn of a game of bingo;

activating a random event generator to generate a number of random events upon which an outcome of the game of bingo is based, the outcome being either an unfavourable outcome in which the player forfeits the wager, and at least one favourable outcome in which the player wins a corresponding prize;

displaying to the player on a secondary display means a simulation of a turn of the game of bingo; and

displaying to the player on a primary display means a simulation of a turn of a different entertainment game, the turn of the different entertainment game having an outcome that is an unfavourable outcome when the outcome of the turn of the game of bingo is an unfavourable outcome, and causing the player to win the same corresponding prize as the game of bingo when the outcome of the turn of the game of bingo is a favourable outcome.

There is further provided for executing the random event generator in a gaming server remote from the plurality of player stations, for providing communication between the gaming server and each one of the plurality of remote player stations by means of a communication network, for establishing the game of bingo with 75 uniquely numbered balls, for configuring a random event generated by the random event generator to correspond to the drawing at random of one of the 75 uniquely numbered balls, for establishing a player bingo card associated with the game of bingo to have 25 positions thereon arranged in a 5 by 5 grid, each grid position being numbered with a respective random number from one to 75, for establishing one favourable outcome of the game of bingo to correspond to a game-ending pattern causing the turn of the game of bingo to terminate, for determining the game-ending pattern to arise when all the numbers on at least one player bingo card match the numbers drawn by the random event generator, for establishing the game of bingo to have a plurality of further favourable outcomes, and for determining each one of the plurality of further favourable outcomes to arise when all the numbers in a predetermined pattern on at least one player bingo card match the numbers drawn by the random event generator.

There is still further provided for drawing at random a first set of 24 of the 75 balls, for transmitting data corresponding to the first set of 24 balls to each one of the player stations, for activating on each one of the player stations a prize claiming means operable by a player to claim any favourable outcome arising from the first set of 24 balls, and for activating the prize claiming means to be operable by a player for a predetermined period of time.

There is yet further provided drawing at random further balls one at a time, for checking for the occurrence of a game-ending pattern on any of the player bingo cards after the drawing of each ball, for transmitting data corresponding to all the drawn balls necessary for the occurrence of the game-ending pattern to each one of the player stations if the game-ending pattern is not the last possible game-ending pattern in the turn of the game of bingo, for activating on each one of the player stations the prize claiming means operable by a player to claim a favourable outcome arising from the occurrence of the game-ending pattern, and for activating the prize claiming means to be operable by a player for a predetermined period of time, and for terminating the turn of the game of bingo if a player claims the favourable outcome within the predetermined period of time.

There is also provided for drawing at random all the remaining balls if the game-ending pattern is the last possible game-ending pattern in the turn of the game of bingo, for transmitting data corresponding to all the drawn balls necessary for the occurrence of the last game-ending pattern and the remaining balls to each one of the player stations, for activating on each one of the player stations the prize claiming means operable by a player to claim a favourable outcome arising from the occurrence of the last possible game-ending pattern, for terminating the turn of the game of bingo if a player claims the favourable outcome, and for activating the prize claiming means until a player claims the favourable outcome.

### BRIEF DESCRIPTION OF THE DRAWINGS

A preferred embodiment of the invention is described below, by way of example only, and with reference to the abovementioned drawings, in which:

FIG. 1 is a functional representation of a system for playing a bingo-type game, according to the invention; and

FIG. 2 is a partial flow chart of the operation of the system of FIG. 1;

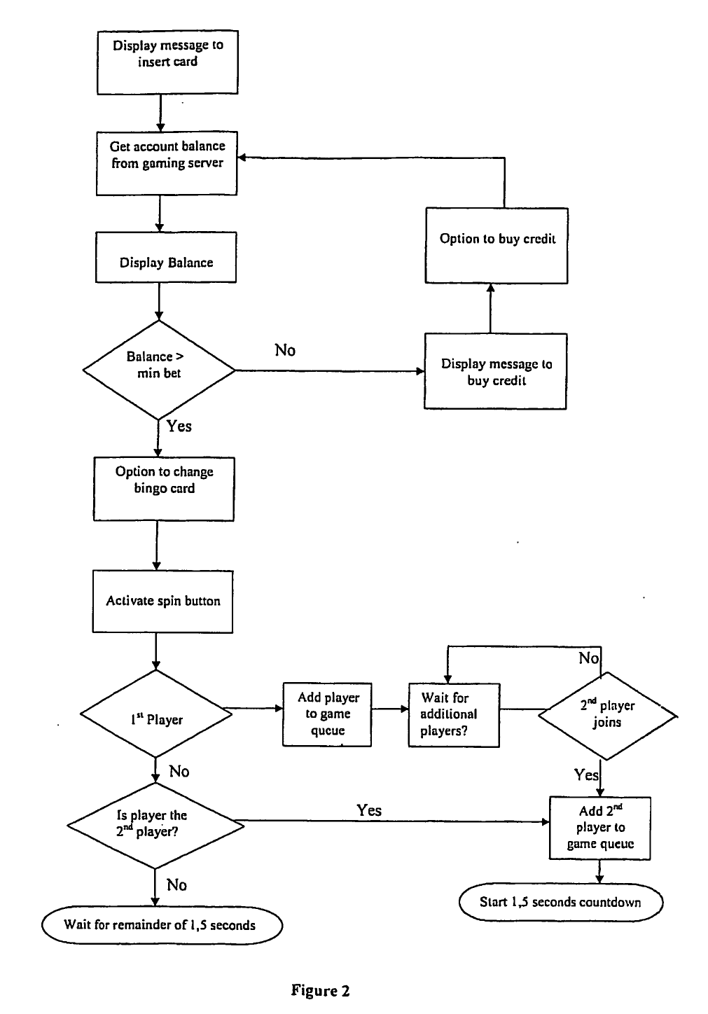

FIG. 3 is a further partial flow chart of the operation of the system of FIG. 1; and

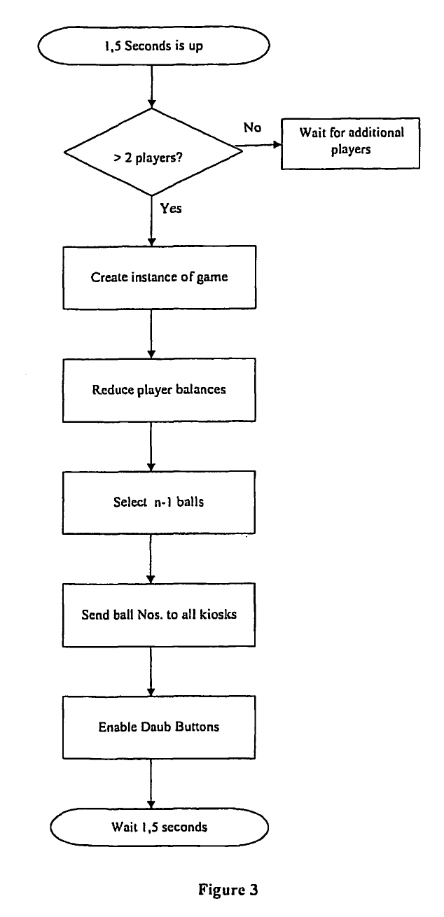

FIG. 4 is a still further partial flow chart of the operation of the system of FIG. 1.

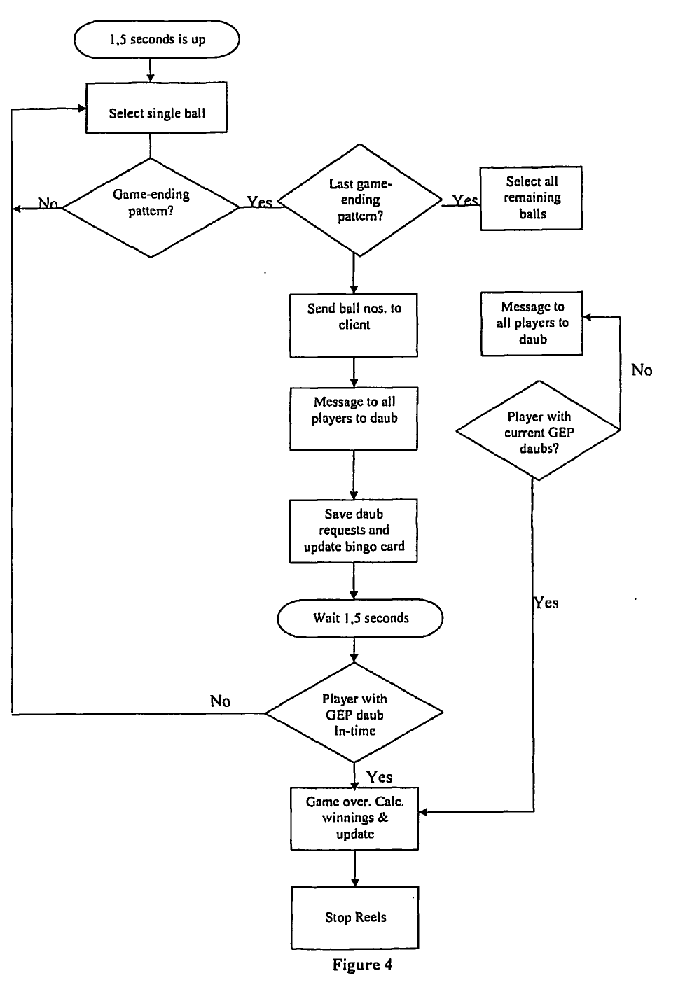

### DETAILED DESCRIPTION OF THE INVENTION

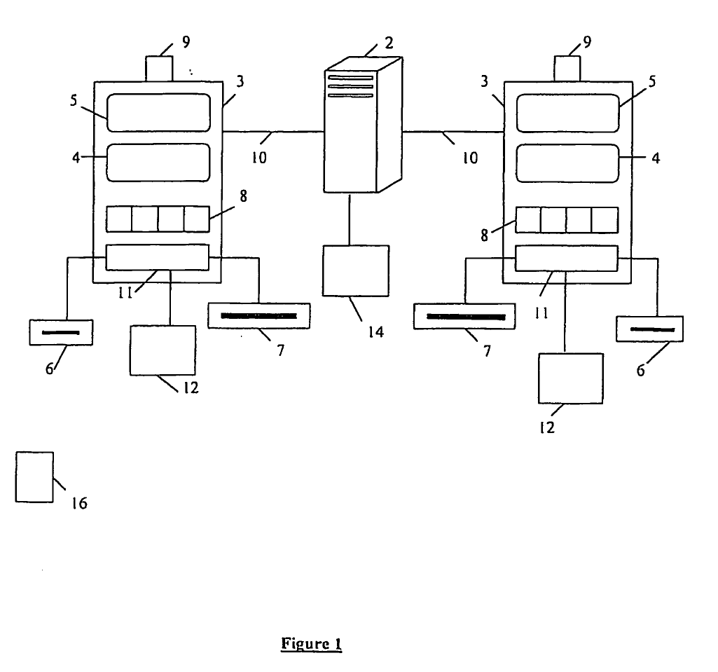

Referring to FIG. 1, a system for playing a bingo-type game is indicated generally by reference numeral (1).

The system (1) for playing a bingo-type game includes a gaming server (2), two or more player stations (3) in the form of freestanding kiosks. Each kiosk has a primary (4) and a secondary (5) display monitor, a magnetic card reader (6), a note validator (7), an array of pushbuttons (8) and a tower light (9). Each kiosk (3) is located remotely from the gaming server (2) and communication between each kiosk and the gaming server is provided by means of a communication network (6) that is, in this embodiment, the Internet.

Each kiosk (3) includes a processor (11) that operates under a Windows XP operating system, which is well known and commercially available from the Microsoft Corporation of Seattle, Wash., USA. The processor (11) executes a client software program (12) that performs at least two functions, namely that of simulating the progress of a game of bingo, and simulating an entertainment feature in the form of a video slots game. The operation of the client software program will be described in more detail in the description that follows.

The game of bingo that can be played by a player on the system (1) comprises a set of 75 predetermined unique symbols that will be referred to, for convenience, as “balls”, numbered from 1 to 75, respectively. A player bingo card has 25 grid positions arranged in an array of five rows and five columns. Each grid position of the array is marked, randomly, with a number between 1 and 75 corresponding to one of the 75 balls available in the game. A player may win a prize by obtaining any one of a number of predetermined patterns of symbols on the bingo card by matching the numbers marked on the grid positions of the bingo card with balls as they are selected (or “drawn”) by the gaming server from the 75 available balls. One of the predetermined winning patterns is designated as a game-ending pattern (“GEP”) that, when obtained by a player, causes the turn of the bingo game to terminate. In this embodiment, the GEP is a “cover all”, that is the number of each of the grid positions on the bingo card must match that of a drawn ball. The remaining prize-winning patterns are referred to as intermediate prize-winning patterns (“IPs”), which do not cause the turn of the bingo game to terminate. Some examples of IPs are: the grid positions in a row or a column of the player's bingo card, the grid positions on the diagonals of the bingo card, or the grid positions at the four corners of the bingo card. It will be appreciated that many other patterns of grid positions on the bingo card, whether regular patterns or random patterns may be designated, a priori, as IPs.

The gaming server (2) operates under a Windows NT operating system that is also well known and commercially available from the Microsoft Corporation. The gaming server (2) includes a random event generator in the form of a computer program (14) that is executable to generate random events upon which an outcome of the game of bingo is based. As an illustration, in order to simulate the drawing of a ball, the random event generation program (14) is executable to select, on a random basis, an integer between 1 and 75 that corresponds to the selection of a corresponding one of the predetermined balls. It will be further appreciated that the random event generator (14) can draw any particular ball only once in any single turn of the bingo game.

A player wishing to use the system (1) is first required to register and to create an account on the gaming server (2). Upon registration, the player is issued with a magnetic card token (16) that has a unique player identification number stored thereon, and a corresponding player account is established on the gaming server (2). The player is then required to pre-fund the account by purchasing credit that will, for convenience, be denominated in this description in “units” of credit. The gaming server (2) stores a credit balance corresponding to the player's account at all times. The player may purchase credit after completion of registration formalities or by inserting banknotes into a note validator (7) on any one of the kiosks (3), which causes the player's credit balance to be to be incremented by the gaming server (2) by the number of units of credit purchased by the player.

In order to commence play, a player inserts his magnetic card token (16) into a magnetic card reader (6) of any one of the kiosks (3) that is available for use. When the magnetic card token (16) has been inserted, the magnetic card reader (6) reads the unique player identification number stored on the magnetic card token and the processor (11) transmits the player identification number to the gaming server (2). The gaming server (2) then obtains the player's credit balance and returns it to the kiosk (3) for display to the player on the primary display monitor (4) of the kiosk (3). The client software program (12) checks whether the player's credit balance is greater than a minimum wager size necessary to play a turn of the game of bingo. If the player's credit balance is smaller than the minimum wager size, a message is displayed to the player on the primary display monitor (4) of the kiosk (3) to fund the account by purchasing credit, which the player can do by introducing one or more banknotes into the note validator (7) on the kiosk. The player's wager is denominated as an integral number of units of credit. The size of the player's wager is displayed on the primary display monitor (4). There must be sufficient credit in the player's account to cover any wager that is made by the player. Data relating to the type and size of the wager made by the player is transmitted by the kiosk (3) across the communication network (6) to the gaming server (2) where it is recorded in a database on an associated storage device (not shown), such as a magnetic or optical storage disk.

When the player does possess, or has acquired, sufficient credit for a minimum bet size, the client software program (12) presents to the player, on the primary display monitor (4), a simulation of a conventional three-reel slot game having an associated prize table. Such three-reel slot games and associated prize tables are well known in the art and will, for this reason, not be described here in detail. The three-reel slot game may have multiple pay lines, may support multiple-coin wagers and may include multiplier symbols that increase game prizes by predetermined integer multiples. The client software program (12) also presents to the player, on the secondary display monitor (5), a representation of a bingo card that the player can use to play the turn of the game, as well as a display of a bingo prize table for the game of bingo. The bingo prize table comprises a list of one or more intermediate prize wining patterns, each with a corresponding intermediate prize for which a player qualifies upon successfully obtaining that pattern, as well as the game-ending, or cover all, pattern with an associated game-ending prize. In this embodiment the game-ending prize associated with the game-ending bingo pattern is a minor prize, namely one fifth of a unit of credit. Each prize in the bingo prize table corresponds to a prize in the prize table associated with the three-reel slots game, which ensures that any prize-winning pattern achieved by a player may be represented as a winning outcome of the three reel slots game that carries the same prize.

One of the buttons on the pushbutton array (8) of the kiosk (3) is labelled “Change Card”. The player may activate this button repeatedly, each activation causing the client software program (12) to display a different bingo card, until the player receives a bingo card with which he is satisfied. Only one player may select any particular bingo card in a turn of the game. A further one of the buttons on the pushbutton array (8) is labelled “Spin”. By depressing the Spin button once, progress of the turn of the game of bingo commences and the client software program (12) animates the three reels of the slot machine game displayed on the primary display screen (4) game to show them spinning.

The bingo-type game is a multiplayer game and at least two players are required in order to play the game. If the player is the first to participate in the turn of the game, the player's details are added to a game queue (not shown) in the gaming server (2), and the client software program (12) initiates a 3-second countdown timer. This countdown timer provides a 3 second interval during which further players may join the game. An advisory message is displayed to the player in the game queue (not shown) that additional players are awaited by the system (1). If a second player does not join the game before expiry of the 3-second countdown timer, the timer is re-initiated, upon expiry thereof, for a further 3-second period and the advisory message is re-displayed to the first player in the game queue. If a second player joins the game by inserting his magnetic card token (10) into a magnetic card reader (6) of a different kiosk (3), the second participating player's details are also added to the game queue, the 3-second countdown timer is cancelled and the bingo simulation software program (12) initiates a second, further countdown timer of 1.5 seconds. The purpose of this second countdown timer is to permit participation in the game by additional players other than those already in the game queue.

At the expiry of the second 1.5-second countdown timer, the gaming server (2) checks that there are still two players in the game queue and establishes a game in accordance with the player selections. The gaming server (2) reduces the credit balance of each participating player by a corresponding amount wagered by that player.

At this stage of the game, the random event generation program (14) randomly selects n−1 balls from the 75 balls available, where n is the number of grid positions on the bingo card, which is, in this embodiment, 25. The gaming server (2) thus effectively “draws” 24 balls. The gaming server (2) transmits the numbers of the balls that have been drawn by the gaming server (2) to the kiosk (3) of each participating player. The client software program in each kiosk (3) displays the balls drawn by the gaming server (2) on the secondary display monitor (5) of that kiosk. A further button on the pushbutton array (8) of each kiosk (3) is labelled “Daub”. When a kiosk (3) receives data relating to the balls drawn by the gaming server (2), the client software program of the kiosk enables the Daub button and initiates a third 1.5-second countdown timer.

The game of bingo is participative in nature and each participating player is required to activate the Daub pushbutton on the pushbutton array of his respective kiosk (3) prior to expiry of that kiosk's third countdown timer. Upon doing so, the 24 drawn balls are matched with the numbers appearing on that player's bingo card and any matching numbers are displayed in a contrasting colour on the secondary display monitor (5). If any player fails to activate the Daub button on the kiosk (3) prior to the expiry of the third 1.5-second countdown timer, that player forfeits any prizes that he may have won after selection of the first 24 balls by the gaming server (2). It will be appreciated by those skilled in the art that it will be impossible for a player to obtain a game-ending pattern, or cover-all, on the basis of the first 24 balls selected by the gaming server (2), as at least 25 balls are required for this to occur. Therefore the game of bingo must continue further, before terminating.

The gaming server (2) then selects further balls, one at a time. After each ball selection the gaming server (2) checks each of the player cards in use by the players for the occurrence of a cover-all game-ending pattern. If no game-ending pattern has occurred, the gaming server (2) will select another ball and check again. This process repeats, one ball at a time, until a game-ending pattern arises. In order to promote a fast-moving game, the gaming server (2) does not transmit data relating to a newly selected ball to the various player kiosks (3) until a game-ending pattern has arisen on any of the player cards. As soon as the game-ending pattern arises, the server checks whether it is a last possible game-ending pattern achievable for that turn of the game. If it is the last possible game-ending pattern, the gaming server (2) then selects all the remaining balls, one at a time, without any further checks. If it is not the last possible game-ending pattern, the gaming server (2) transmits data relating only to the balls selected thus far to the various kiosks (3) for display to the players on the secondary display monitors (5) of the kiosks. Each player will then have a further period of 1.5 seconds, as measured by a fourth countdown timer within which to activate the Daub button a further time. If any player eligible to win a prize associated with the game-ending pattern fails to activate the Daub button on the kiosk (3) prior to the expiry of the fourth 1.5-second countdown timer, that player forfeits the game-ending prize. This forfeiture is known, in bingo, as “sleeping the bingo”. Each time any player activates the Daub button, the client program transmits data relating to such activation to the gaming server (2), together with an associated time stamp, in order that the gaming server may determine which prizes, if any, the player qualifies for. As soon as any player activates the Daub button, that player's bingo card is updated to reflect any matching numbers drawn thus far by the gaming server (2).

If a player or players with a game-ending pattern does not activate the Daub button within the permitted time, the gaming server will continue to select a single ball at a time until a further game-ending pattern is reached. If a player with a game-ending pattern does activate the Daub button within the permitted time, the turn of the bingo game terminates.

Once the game-ending pattern is obtained and claimed by one or more qualifying players, the gaming server (2) determines the prizes won by the various players, whether for obtaining an intermediate patterns or the game-ending pattern. The determination is made according to the following rules:
1. to qualify for a prize associated with an intermediate pattern or a game-ending pattern, the player must have obtained the required pattern of balls on his bingo card and daubed within the specified time period, that is before the next ball is selected by the gaming server (2);
2. if two or more players obtain and claim the game-ending pattern by daubing, the first player to daub will be awarded the prize associated with the game-ending pattern;
3. if two or more players obtain and claim a same intermediate pattern, they are each awarded a prize associated with that intermediate pattern; and
4. any player qualifying for and claiming more than one prize, whether intermediate or game-ending, will only be awarded the largest of the prizes.

Once the gaming server (2) has completed the prize determination as described above, the credit balances of the various accounts of the participating players are updated on the gaming server and transmitted by the gaming server to the various kiosks (3) for display to the respective players on the primary display monitors (5). At the same time, the client software program (12) of each kiosk (3) causes the animation of the spinning reels of the three-reel slot game to slow down and to cause the reels to come to rest at positions that correspond to the prize won by the player in the underlying bingo game. Where a player has not won an intermediate prize in the bingo game, the reels will stop with a result that does not correspond to a prize in the slots prize table. Where a player has won an intermediate prize in the bingo game, the reels will stop at a result that is associated with a prize in the slots prize table that is equal to the prize in the bingo prize table associated with the intermediate pattern obtained by that player.

It is possible that, after the gaming server (2) has selected all 75 balls, no participating player claims a game-ending pattern within the allowed time period. In such an instance, the client software program (12) displays a prominent message to each player, on the primary display monitor (5), to daub. In order to urge the participating players to terminate the turn of the game of bingo, the gaming server (2) instructs the client software program (12) in each kiosk (3) to cause the tower light (9) of each kiosk to flash in order to prompt the participating players to daub again in order to bring the turn of the game to an end. In this instance, the client software program (12) does not initiate a countdown timer, and only the player who obtained the last possible game-ending pattern will be able to end the turn of the game by daubing.

It will be appreciated by those skilled in the art that the elements of the game that relate to the bingo-type game are all presented to a participating player on the secondary display monitor (5), while all the elements of the game that relate to the slots game are presented to the player on the primary display monitor (4). In this manner, the player is able to enjoy an experience associated with a game of slots, whilst, in reality playing a game of participative bingo. It will be appreciated that the slots game is merely an entertainment feature used to represent any prizes won by the participating players in the underlying game of bingo. This is advantageous as the system may be used to enable players to experience a slots game in jurisdictions where participative games of chance such as bingo are permitted and games such as traditional casino games are not permitted, such as Class II gaming jurisdictions.

Numerous modifications are possible to this embodiment. Firstly, a kiosk (3) may only be equipped with a single display monitor, in which case the elements displayed separately on the primary and secondary display monitors (4 and 5) are combined for presentation to a player. In this instance, the bingo-related elements may be presented in reduced scale adjacent the slots-related elements in order to maintain the emphasis on the presentation of the slots game. Secondly, the pushbutton array (8) may be dispensed with and replaced with a touch-sensitive area on the primary display monitor. Further, the entertainment element of the bingo-type game may be a simulation of a game other than a three-reel slots game such as, for example, a game of video poker. Still further, the parameters of the underlying bingo game, such as number of balls, bingo card layouts and winning patterns of symbols may be altered to enhance the attractiveness of the bingo game to players and to provide for bigger prizes to be won.

The invention therefore provides a system for playing a bingo-type game that includes an entertainment feature that will allow participating players to play the game with minimal emphasis on the bingo elements of the game.

1. A system for playing a bingo-type game, comprising:
a plurality of player stations, each player station being operable by a respective player to place a wager on a turn of a game of bingo;
a random event generator activatable to generate a number of random events upon which an outcome of the game of bingo is based, the outcome being either an unfavourable outcome in which the player forfeits the wager, and at least one favourable outcome in which the player wins a corresponding prize;
a secondary display means instructable by the player station to display a simulation of the turn of the game of bingo; and
a primary display means instructable by the player station to display to the player a simulation of a turn of a different entertainment game having an outcome that is unfavourable when the outcome of the turn of the game of bingo is an unfavourable outcome, the turn of the different entertainment game causing the player to win the same corresponding prize as the game of bingo when the outcome of the turn of the game of bingo is a favourable outcome.

2. A system as claimed in claim 1 in which the random event generator is executable in a gaming server remote from the plurality of player stations, the gaming server being communicable with each one of the plurality of remote player stations by means of a communication network.

3. A system as claimed in claim 1 in which the different entertainment game is a game of video slots.

4. A system as claimed in claim 1 in which the game of bingo has 75 uniquely numbered balls and in which a random event generated by the random event generator corresponds to the drawing at random of one of the 75 uniquely numbered balls.

5. A system as claimed in claim 4 in which a player bingo card associated with the game of bingo has 25 positions thereon arranged in a 5 by 5 grid, each grid position being numbered with a respective random number from 1 to 75.

6. A system as claimed in claim 5 in which one favourable outcome of the game of bingo as a game-ending pattern causing the turn of the game of bingo to terminate.

7. A system as claimed in claim 6 in which the game-ending pattern arises when each number on at least one player bingo card matches a number drawn by the random event generator.

8. A system as claimed in claim 7 in which the game of bingo has a plurality of further favourable outcomes, each one arising when all the numbers in a respective predetermined pattern on at least one player bingo card match the numbers drawn by the random event generator.

9. A system as claimed in claim 4 in which the random event generator draws at random a first set of 24 of the 75 balls and transmits data corresponding to the first set of 24 balls to each one of the player stations.

10. A system as claimed in claim 9 in which each one of the player stations includes a prize claiming means operable by a player to claim any favourable outcome arising from the first set of 24 balls.

11. A system as claimed in claim 10 in which the prize claiming means is any one of a pushbutton on the player station or an activatable icon on the primary display means.

12. A system as claimed in claim 10 in which the prize claiming means is operable by a player for a predetermined period of time.

13. A system as claimed in claim 9 in which the random event generator draws at random further balls one at a time and the gaming server checks for the occurrence of a game-ending pattern on any of the player bingo cards after the drawing of each ball.

14. A system as claimed in claim 13 in which the gaming server transmits data corresponding to all the drawn balls necessary for the occurrence of the game-ending pattern to each one of the player stations if the game-ending pattern is not the last possible game-ending pattern in the turn of the game of bingo.

15. A system as claimed in claim 14 in which each one of the player stations activates its respective prize claiming means for a predetermined period of time to be operable by a player to claim a favourable outcome arising from the occurrence of the game-ending pattern.

16. A system as claimed in claim 15 in which the gaming server terminates the turn of the game of bingo if a player claims the favourable outcome within the predetermined period of time.

17. A system as claimed in claim 16 in which the random event generator draws at random all the remaining balls if the game-ending pattern is the last possible game-ending pattern in the turn of the game of bingo and the gaming server transmits data corresponding to all the drawn balls necessary for the occurrence of the last game-ending pattern and the remaining balls to each one of the player stations.

18. A system as claimed in claim 17 in which each one of the player stations activates its respective prize claiming means to be operable by a player to claim a favourable outcome arising from the occurrence of the last possible game-ending pattern.

19. A system as claimed in claim 18 in which the gaming server terminates the turn of the game of bingo if a player claims the favourable outcome.

20. A system as claimed in claim 19 in which the prize claiming means remains activated until a player claims the favourable outcome.

21. A method of operation of a system for playing a bingo-type game, comprising the steps of:
enabling each one of a plurality of player stations for operation by a respective player to place a wager on a turn of a game of bingo;
activating a random event generator to generate a number of random events upon which an outcome of the game of bingo is based, the outcome being either an unfavourable outcome in which the player forfeits the wager, and at least one favourable outcome in which the player wins a corresponding prize;
displaying to the player on a secondary display means a simulation of a turn of the game of bingo; and
displaying to the player on a primary display means a simulation of a turn of a different entertainment game having an outcome that is unfavourable when the outcome of the turn of the game of bingo is an unfavourable outcome, the turn of the different game causing the player to win the same corresponding prize as the game of bingo when the outcome of the turn of the game of bingo is a favourable outcome.

22. A method as claimed in claim 21 in which the random event generator is executed in a gaming server remote from the plurality of player stations and in which communication is provided between the gaming server and each one of the plurality of remote player stations by means of a communication network.

23. A method as claimed in claim 21 in which the game of bingo is established with 75 uniquely numbered balls and in which a random event generated by the random event generator is configured to correspond to the drawing at random of one of the 75 uniquely numbered balls.

24. A method as claimed in claim 23 which includes a step of establishing a player bingo card associated with the game of bingo to have 25 positions thereon arranged in a 5 by 5 grid, each grid position being numbered with a respective random number from one to 75.

25. A method as claimed in claim 24 in which one favourable outcome of the game of bingo is a game-ending pattern causing the turn of the game of bingo to terminate.

26. A method as claimed in claim 25 in which the game-ending pattern is determined as arising when each number on at least one player bingo card matches a number drawn by the random event generator.

27. A method as claimed in claim 26 in which the game of bingo has a plurality of further favourable outcomes, each one arising when all the numbers in a predetermined pattern on at least one player bingo card match the numbers drawn by the random event generator.

28. A method as claimed in claim 23 in which a first set of 24 of the 75 balls is drawn at random and data corresponding to the first set of 24 balls is transmitted to each one of the player stations.

29. A method as claimed in claim 28 which includes a further step of activating a prize claiming means on each one of the player stations, for a predetermined period of time the prize claiming means being operable by a player to claim any favourable outcome arising from the first set of 24 balls.

30. A method as claimed in claim 29 in which further balls are drawn at random, one at a time, and the occurrence of a game-ending pattern on any of the player bingo cards is checked after the drawing of each ball.

31. A method as claimed in claim 30 in which data corresponding to all the drawn balls necessary for the occurrence of the game-ending pattern is transmitted to each one of the player stations if the game-ending pattern is not the last possible game-ending pattern in the turn of the game of bingo.

32. A method as claimed in claim 31 in which the prize claiming means is activated on each one of the player stations for a predetermined period of time, each prize claiming means being operable by a player to claim a favourable outcome arising from the occurrence of the game-ending pattern.

33. A method as claimed in claim 32 in which the turn of the game of bingo is terminated if a player claims the favourable outcome within the predetermined period of time.

34. A method as claimed in claim 33 in which all the remaining balls are drawn at random if the game-ending pattern is the last possible game-ending pattern in the turn of the game of bingo and data corresponding to all the drawn balls necessary for the occurrence of the last game-ending pattern and to the remaining balls is transmitted to each one of the player stations.

35. A method as claimed in claim 34 in which the prize claiming means is activated on each one of the player stations, the prize claiming means being operable by a player to claim a favourable outcome arising from the occurrence of the last possible game-ending pattern.

36. A method as claimed in claim 35 in which the turn of the game of bingo terminates if a player claims the favourable outcome.

37. A method as claimed in claim 36 that includes the step of activating the prize claiming means until a player claims the favourable outcome.
